(19) United States
(12) Patent Application Publication
(10) Pub. No.: US 2012/0000169 A1
(43) Pub. Date: Jan. 5, 2012

(54) Dust-Filtering Apparatus for a Computer

(76) Inventor: Hojin Ahn, San Jose, CA (US)

(21) Appl. No.: 12/828,298

(22) Filed: Jul. 1, 2010

(51) Int. Cl. B01D 50/00

(52) U.S. Cl. 55/383

(57) ABSTRACT

A novel dust-filtering apparatus for a computer is disclosed. In one embodiment of the invention, the dust-filtering apparatus causes an inflow of air into a filtering chamber by using an air fan which is operatively connected to a DC power source. The inflow of air into the filtering chamber is cleaned and filtered by a first side of a filtering medium which is located on one side of the filtering chamber. A second side of the filtering medium faces a cleaned air evacuation chamber, which has at least an opening to allow the cleaned air to evacuate outwardly from the dust-filtering apparatus. In one embodiment of the invention, the dust-filtering apparatus is designed to be inserted into a drive expansion bay of a desktop computer, with a door on a front side of the dust-filtering apparatus for easy removal of the filtering medium.

### BACKGROUND OF THE INVENTION

The present invention generally relates to a computer peripheral device. More specifically, the invention relates to an apparatus for filtering dust particles inside a computer casing.

A typical desktop personal computer (PC) in the market today has one or more air cooling fans which are designed to dissipate heat from a central processing unit (CPU), a graphics chip, a power supply unit, a storage device, and/or other components inside a computer casing. An air cooling fan typically has an external opening to an outer surface of the computer casing in order to induce an inflow or an outflow of air when the air cooling fan is operational. The use of the air cooling fan invariably attracts foreign particles into the external opening, including dusts, small insects, and other undesirable substances. As a result, many desktop computers with a significant amount of air cooling fan operating hours are typically filled with undesirable dusts, which hamper efficient heat dissipation and reduce performance and reliability of desktop computers.

In order to resolve problems associated with dust attraction through an external opening for a cooling fan, the computer industry has devised a few solutions. One notable conventional solution is a dust screen filter which covers or encapsulates the external opening for the cooling fan of a desktop computer. In such designs, the dust screen filter, typically made of fine meshed screens, prevents dusts from coming into the external opening. However, the use of the dust screen filter near the external opening fundamentally reduces the rate of airflow into or out of the external opening. Furthermore, the dust screen filter also collects dust on one side of the dust screen rapidly, and if a user does not clean or replace the dust screen filter very often, it may further reduce the rate of airflow into or out of the external opening and even cause overheating problems inside a computer casing.

Accordingly, a novel apparatus which provides effective filtering of dusts inside a computer without blocking airflow into or out of a main cooling fan of a computer casing may be beneficial. Furthermore, a novel apparatus which also provides an easy replacement or cleaning of a filtering medium may be beneficial.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, an apparatus for filtering dust particles inside a computer casing is disclosed. This apparatus comprises an air fan designed to cause an inflow of air from other parts of the computer casing into a filtering chamber of the apparatus, wherein the air fan is operatively connected to an electrical power supply unit; a filtering medium located between the filtering chamber and a cleaned air evacuation chamber of the apparatus, wherein the filtering medium is designed to filter the dust particles within the filtering chamber and pass cleaned air to the cleaned air evacuation chamber; and an opening in the cleaned air evacuation chamber, wherein the opening allows the cleaned air to evacuate to the other parts of the computer casing.

In another embodiment of the invention, an expansion bay-insertable computer dust-filter apparatus is disclosed. This apparatus comprises one or more air fans designed to cause an inflow of air from other parts of the computer casing into a filtering chamber of the expansion bay-insertable computer dust-filter apparatus, wherein the one or more air fans are operatively connected to an electrical power supply unit; a filtering medium located between the filtering chamber and a cleaned air evacuation chamber of the expansion bay-insertable computer dust-filter apparatus, wherein the filtering medium is designed to filter the dust particles within the filtering chamber and pass cleaned air to the cleaned air evacuation chamber; and a plurality of holes in the cleaned air evacuation chamber, wherein the plurality of holes allow the cleaned air to evacuate to the other parts of the computer casing.

### BRIEF DESCRIPTION OF DRAWINGS

FIG. 1 shows a perspective diagram of a computer casing with a main cooling fan, a power supply, and a plurality of drive expansion bays in accordance with an embodiment of the invention.

FIG. 2 shows a perspective diagram of a dust-filtering apparatus for a computer in accordance with an embodiment of the invention.

FIG. 3 shows a perspective diagram of a dust-filtering apparatus for a computer in accordance with another embodiment of the invention.

FIG. 4 shows a perspective diagram of a dust-filtering apparatus inserted into a drive expansion bay of a computer casing, in accordance with an embodiment of the invention.

FIG. 5 shows a perspective diagram of a dust-filtering apparatus with a door with a hinge on one edge near a cleaned air evacuation chamber and a knob on the front faceplate of the door, in accordance with an embodiment of the invention.

FIG. 6 shows a cutaway perspective diagram of a dust-filtering apparatus with a filter holding clip and a slide rail for a filtering medium, in accordance with an embodiment of the invention.

FIG. 7 shows a cartridge-type filtering medium configured to slide into a filtering chamber of a dust-filtering apparatus, in accordance with an embodiment of the invention.

FIG. 8 shows a method of operating a dust-filtering apparatus in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble an apparatus for filtering dust particles inside a computer casing. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

For the purpose of describing the invention, a term “main cooling fan” is defined as a cooling fan attached near or on a computer casing to induce air cooling inside the computer casing.

Furthermore, for the purpose of describing the invention, a term “air fan” is defined as an electrically-powered fan on a dust-filter apparatus to cause an inflow of air from other parts of a computer casing into a filtering chamber of the dust-filter apparatus.

In addition, for the purpose of describing the invention, a term “filtering medium” is defined as a filtering layer, a cartridge-type filter, or a box-like structure which is designed to face at least one side of a filtering chamber and filter dust particles from an inflow of air caused by an air fan.

Moreover, for the purpose of describing the invention, a term “filtering chamber” is defined as a region which receives an inflow of air from an air fan and faces at least on side of a filtering medium.

Furthermore, for the purpose of describing the invention, a term “cleaned air evacuation chamber” is defined as a region which has at least one opening to allow cleaned air from a filtering chamber to evacuate outwardly. In one embodiment of the invention, the cleaned air evacuation chamber has an air-tight front door and a plurality of openings, or micro holes on top, bottom, left, or right surfaces of a dust-filtering apparatus.

Accordingly, a dust-filtering apparatus for a computer is disclosed as an apparatus for filtering dust particles inside a computer casing. One aspect of the present invention is providing an expansion bay-insertable dust-filter apparatus for easy installation and replacement or cleaning of a filtering medium by a user. Another aspect of the present invention is to provide an apparatus to filter dust particles inside a computer casing proactively without blocking an airflow into or out of a main cooling fan for a computer casing. Yet another aspect of the present invention is to utilize standard expansion bay dimensions and power connection sources for a desktop computer to design a dust-filtering apparatus which may occupy a single slot or multiple slots in the expansion bay section of a desktop computer casing, depending on a desired air filtering capacity of the dust-filtering apparatus.

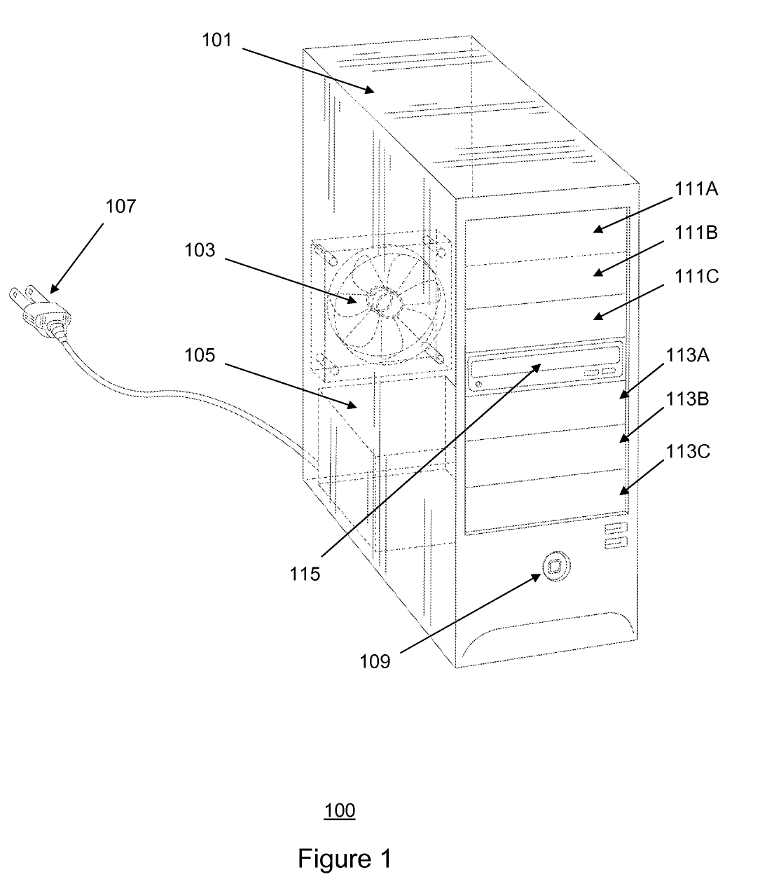

FIG. 1 shows a perspective diagram (100) of a computer casing (101) with a main cooling fan (103), a power supply unit (105), a plurality of drive expansion bays (111A˜111C, 113A˜113C) without a dust-filtering apparatus of the present invention inserted into a slot, a DVD drive (115), and an on/off power switch (109), and a power cord (107) in accordance with an embodiment of the invention. The perspective diagram (100) of FIG. 1, like other figures drawn for this Specification, illustrates internal views of the computer casing (101) in perforated lines for conceptual clarity. In a preferred embodiment of the invention, the main cooling fan (103) is operatively connected to the power supply unit (105) which typically provides either an AC or a DC voltage to the main cooling fan (103) directly or indirectly. In one embodiment of the invention, the main cooling fan (103) is also operatively connected to an intermediate transformer unit for AC to DC conversion from the power supply unit (105).

In the preferred embodiment of the invention, the power supply unit (105) is operatively connected to the power cord (107) which is designed to plug into an electrical outlet. The computer casing (101) also contains the plurality of drive expansion bays (e.g. 111A˜111C, 113A˜113C), which are typically located near a frontal surface of the computer casing (101) as shown in FIG. 1. The computer casing (101) also has the on/off power switch (109) on the frontal surface and the DVD drive (115) inserted into one slot of the expansion bays.

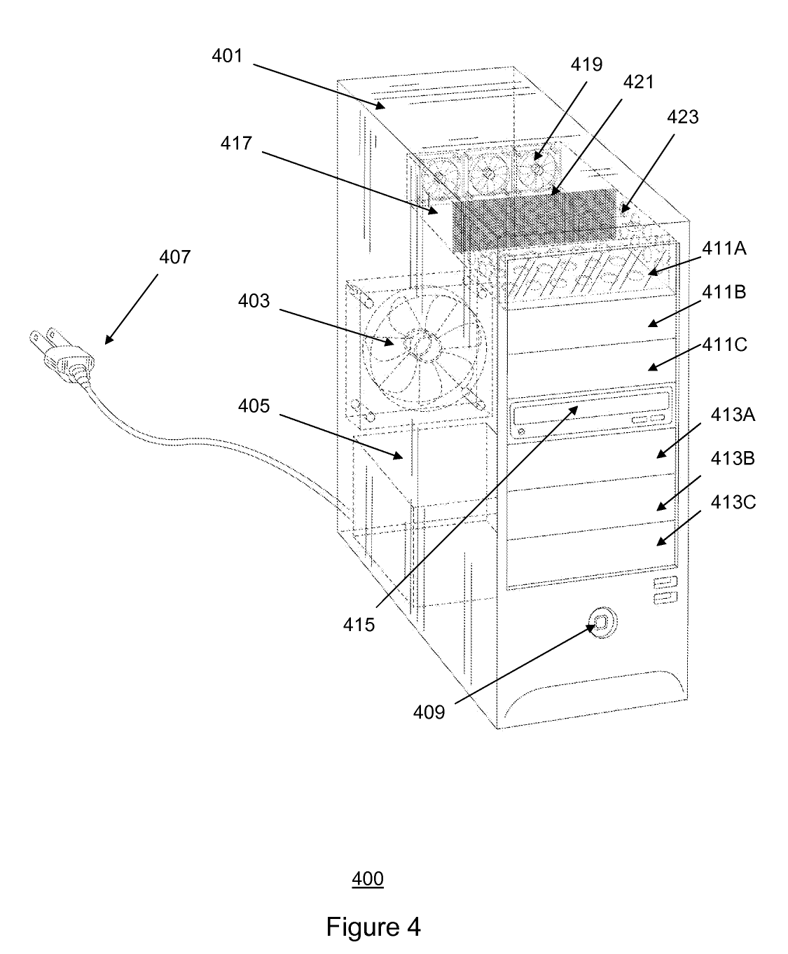

Continuing with FIG. 1, a primary function of the main cooling fan (103) is to induce airflow into or out of the computer casing (101) for forced air-cooling effect inside the computer casing (101). Common sources of heat inside a computer include, but are not limited to, a microprocessor, a graphics processor, a network card, other components in a motherboard, and a display driver. If a dust-filtering apparatus of the present invention is inserted into one or more slots in drive expansion bays (e.g. 111A˜111C, 113A˜113C), then a corresponding illustration can be similar to FIG. 4. Common computer components such as a motherboard, a microprocessor, a graphics card, a networking chipset, and electrical transmission lines inside the computer casing (101 of FIG. 1, 401 of FIG. 4) are not drawn in FIG. 1 or FIG. 4 for simplification and clarity of the invention.

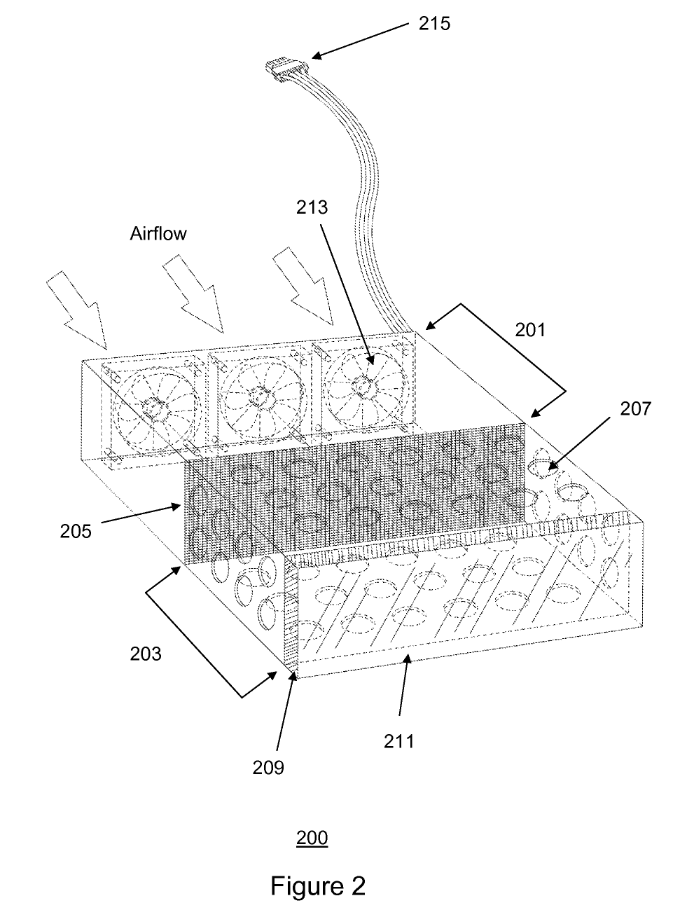

FIG. 2 shows a perspective diagram of a dust-filtering apparatus (200) for a computer in accordance with an embodiment of the invention. In a preferred embodiment of the invention, the dust-filtering apparatus (200) comprises an air fan (213) designed to cause an inflow of air from outside the dust-filtering apparatus (200) (i.e. other parts of a computer casing) into a filtering chamber (201) of the dust-filtering apparatus (200). The air fan (213) is operatively connected to an electrical power supply unit through a power connector (215). In the preferred embodiment of the invention, the electrical power supply unit may be sharing a same power source with other devices designed to fit into expansion slots.

The dust-filtering apparatus (200) also has a filtering medium (205) located between the filtering chamber (201) and a cleaned air evacuation chamber (203). In the preferred embodiment of the invention, the filtering medium (205) is designed to filter dust particles within the filtering chamber (201) and pass cleaned air to the cleaned air evacuation chamber (203). Furthermore, the dust-filtering apparatus (200) also has one or more openings (207) which allow the cleaned air to evacuate outside (i.e. to other parts of the computer casing) from the dust-filtering apparatus (200). In the preferred embodiment of the invention, the dust-filtering apparatus (200) has a door (211) or a front faceplate with an air-tight caulking material (209) to prevent much of cleaned air from escaping through a front surface of the dust-filtering apparatus (200). The door (211) or the front faceplate prevents the cleaned air from blowing directly out of one or more expansion bay front plates, which may be annoyance or inconvenience to a computer user.

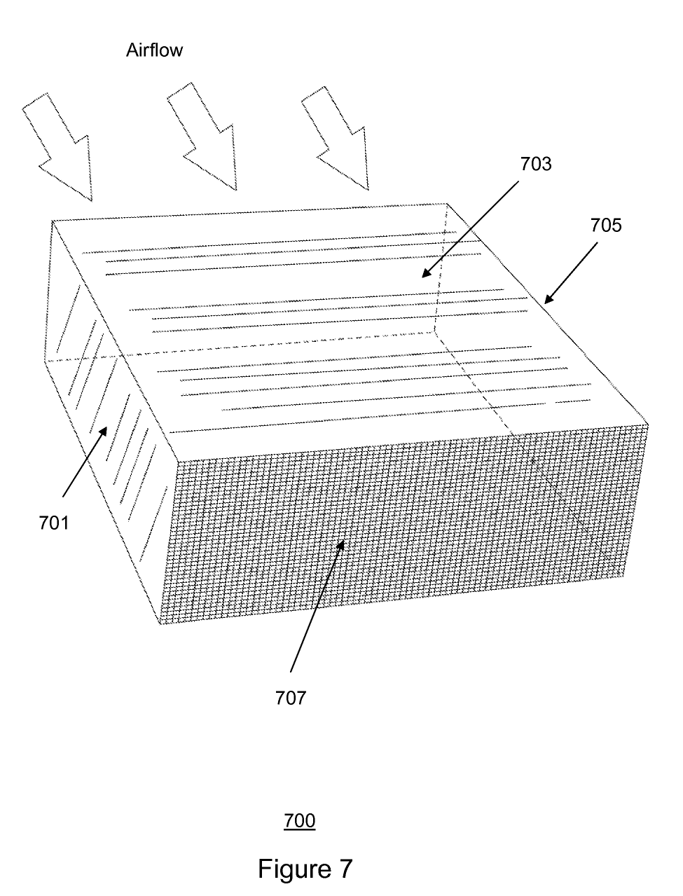

Continuing with FIG. 2, a multiple number of air fans (213) can be used to force air into the filtering chamber (201) depending on desired air cleaning processing rates and capacities. In a preferred embodiment of the invention, the filtering medium (205) can be a HEPA (high efficiency particulate air) filter layer, a finely meshed screen, a paper filter, a fiber filter, a cartridge-type/box-shaped filter (e.g. 700 of FIG. 7), or any other material which effectively collect dusts on a first surface of the filtering medium (205) facing the filtering chamber (201) and pass cleaned air to the cleaned air evacuation chamber (203). The filtering medium (205) can also have an air-tight caulking material around outer edges of the filtering medium (205) to prevent accidental passage of the dust particles through the outer edges of the filtering medium (205) in the filtering chamber (201). Furthermore, the door (211) or the front faceplate of the dust-filtering apparatus (200) can be opened by a user for easy access, replacement, or cleaning of the filtering medium (205). In one embodiment of the invention, the door (211) may have a hinge (e.g. 519) and a knob (e.g. 517) for easy opening of the frontal surface of the dust-filtering apparatus (200). In the preferred embodiment of the invention, relatively few dusts may be present in the cleaned air evacuation chamber (203) because most dusts are collected by a first surface of filtering medium (205) facing the filtering chamber (201). Therefore, potential clogging of one or more openings (207) by dusts may be minimal or negligible on a second surface of the filtering medium (205) facing the cleaned air evacuation chamber (203) as long as the filtering medium (205) is regularly replaced or cleaned by the user.

Furthermore, in the preferred embodiment of the invention, the dust-filtering apparatus (200) is designed to be inserted into one or more slots for drive expansion bays, and the air fan (213) is operatively connected to an electrical power supply unit which also provides power to another device in another drive expansion bay. In addition, in one embodiment of the invention, the filtering chamber (201) is made of air-tight solid materials for top, bottom, and sidewalls to prevent escape of the inflow of air and to maximize air filtering effectiveness of the filtering medium (205) placed in a frontal portion of the filtering chamber (201).

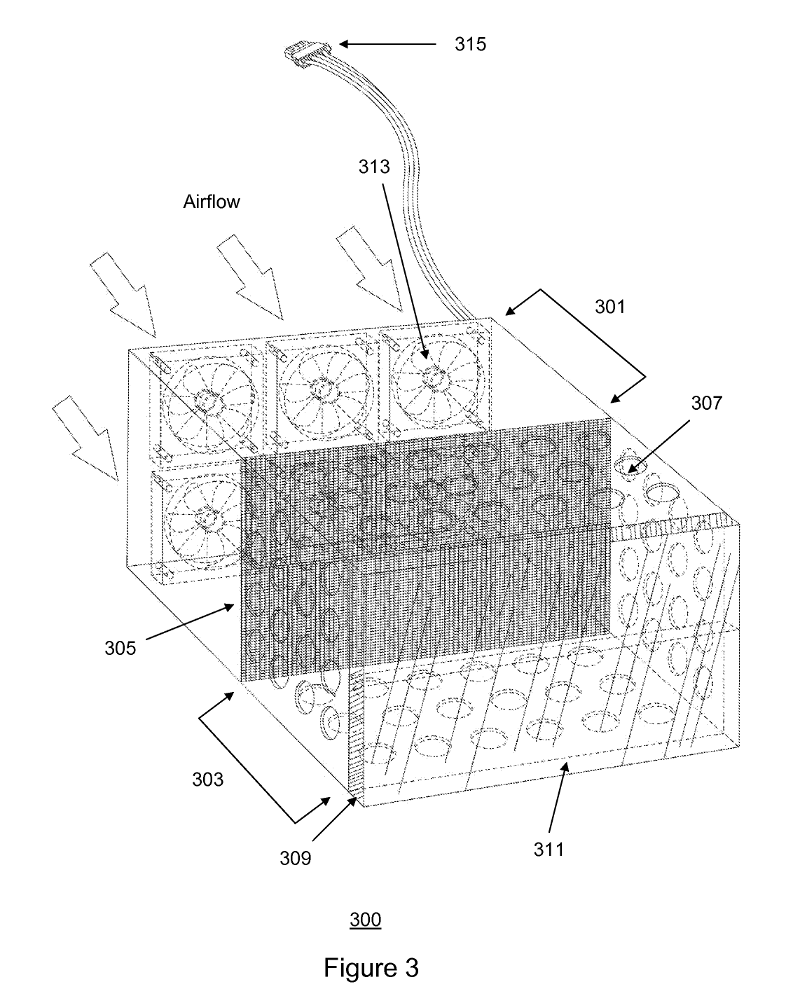

FIG. 3 shows a perspective diagram of another dust-filtering apparatus (300) for a computer in accordance with another embodiment of the invention. In a preferred embodiment of the invention, this dust-filtering apparatus (300) has more air fans than a dust-filtering apparatus (200) of FIG. 2 for a higher rate of filtering and a higher processing capacity. In a preferred embodiment of the invention, the dust-filtering apparatus (300) can occupy a multiple number of drive expansion slots in a desktop computer casing for installation. Similar to the dust-filtering apparatus (200) of FIG. 2, the dust-filtering apparatus (300) of FIG. 3 comprises a plurality of air fans (313) designed to cause an inflow of air from outside the dust-filtering apparatus (300) (i.e. other parts of a computer casing) into a filtering chamber (301) of the dust-filtering apparatus (300). Each air fan (313) is operatively connected to an electrical power supply unit through a power connector (315). In the preferred embodiment of the invention, the electrical power supply unit for the dust-filtering apparatus may be sharing a same power source with other devices designed to fit into expansion slots.

The dust-filtering apparatus (300) also has a filtering medium (305) located between the filtering chamber (301) and a cleaned air evacuation chamber (303). In the preferred embodiment of the invention, the filtering medium (305) is designed to filter dust particles within the filtering chamber (301) and pass cleaned air to the cleaned air evacuation chamber (303). Furthermore, the dust-filtering apparatus (300) also has one or more openings (307) which allow the cleaned air to evacuate outside (i.e. to other parts of the computer casing) from the dust-filtering apparatus (300). In the preferred embodiment of the invention, the dust-filtering apparatus (300) has a door (311) or a front faceplate with an air-tight caulking material (309) to prevent much of cleaned air from escaping through a front surface of the dust-filtering apparatus (300). The door (311) or the front faceplate prevents the cleaned air from blowing directly out of one or more expansion bay front plates, which may be annoyance or inconvenience to a computer user.

Continuing with FIG. 3, a multiple number of air fans (313) can be used to force air into the filtering chamber (301) depending on desired air cleaning processing rates and capacities. In a preferred embodiment of the invention, the filtering medium (305) can be a HEPA (high efficiency particulate air) filter layer, a finely meshed screen, a paper filter, a fiber filter, a cartridge-type/box-shaped filter (e.g. 700 of FIG. 7), or any other material which effectively collect dusts on a first surface of the filtering medium (305) facing the filtering chamber (301) and pass cleaned air to the cleaned air evacuation chamber (303). The filtering medium (305) can also have an air-tight caulking material around outer edges of the filtering medium (305) to prevent accidental passage of the dust particles through the outer edges of the filtering medium (305) in the filtering chamber (301). Furthermore, the door (311) or the front faceplate of the dust-filtering apparatus (300) can be opened by a user for easy access, replacement, or cleaning of the filtering medium (305). In one embodiment of the invention, the door (311) may have a hinge (e.g. 519) and a knob (e.g. 517) for easy opening of the frontal surface of the dust-filtering apparatus (300). In the preferred embodiment of the invention, relatively few dusts may be present in the cleaned air evacuation chamber (303) because most dusts are collected by a first surface of filtering medium (305) facing the filtering chamber (301). Therefore, potential clogging of one or more openings (307) by dusts may be minimal or negligible on a second surface of the filtering medium (305) facing the cleaned air evacuation chamber (303) as long as the filtering medium (305) is regularly replaced or cleaned by the user.

Furthermore, in the preferred embodiment of the invention, the dust-filtering apparatus (300) is designed to be inserted into one or more slots for drive expansion bays, and the air fan (313) is operatively connected to an electrical power supply unit which also provides power to another device in another drive expansion bay. In addition, in one embodiment of the invention, the filtering chamber (301) is made of air-tight solid materials for top, bottom, and sidewalls to prevent escape of the inflow of air and to maximize air filtering effectiveness of the filtering medium (305) placed in a frontal portion of the filtering chamber (301). The dust-filtering apparatus (300) of FIG. 3 can take two or more slots in drive expansion bays to incorporate more air fans for a higher filtering capacity.

FIG. 4 shows a perspective diagram of a dust-filtering apparatus (417, 419, 421, 423) inserted into a drive expansion bay slot (411A) of a computer casing (401), in accordance with an embodiment of the invention. This figure also shows a perspective diagram (400) of a computer casing (401) with a main cooling fan (403), a power supply unit (405), a plurality of drive expansion bays (411A˜411C, 413A˜413C) with a dust-filtering apparatus (417, 419, 421, 423) of the present invention inserted into a drive expansion bay slot (411A), a DVD drive (415), an on/off power switch (409), and a power cord (407) in accordance with an embodiment of the invention. The perspective diagram (400) of FIG. 4, like other figures drawn for this Specification, illustrates internal views of the computer casing (401) in perforated lines for conceptual clarity. In a preferred embodiment of the invention, the main cooling fan (403) is operatively connected to the power supply unit (405) which typically provides either an AC or a DC voltage to the main cooling fan (403) directly or indirectly. In one embodiment of the invention, the main cooling fan (403) is also operatively connected to an intermediate transformer unit for AC to DC conversion from the power supply unit (405). Common computer components such as a motherboard, a microprocessor, a graphics card, a networking chipset, and electrical transmission lines inside the computer casing (101 of FIG. 1, 401 of FIG. 4) are not drawn in FIG. 1 or FIG. 4 for simplification and clarity of the invention.

In the preferred embodiment of the invention, the power supply unit (405) is operatively connected to the power cord (407) which is designed to plug into an electrical outlet. The computer casing (401) also contains the plurality of drive expansion bays (e.g. 411A˜411C, 413A˜413C), which are typically located near a frontal surface of the computer casing (401) as shown in FIG. 4. The computer casing (401) also has the on/off power switch (409) on the frontal surface and the DVD drive (415) inserted into one slot of the expansion bays.

Continuing with FIG. 4, a primary function of the main cooling fan (403) is to induce airflow into or out of the computer casing (401) for forced air-cooling effect inside the computer casing (401). Common sources of heat inside a computer include, but are not limited to, a microprocessor, a graphics processor, a network card, other components in a motherboard, and a display driver. As shown in FIG. 4, the dust-filtering apparatus (417, 419, 421, 423) is inserted into a single drive expansion bay slot (411A). The dust-filtering apparatus (417, 419, 421, 423) comprises a filtering chamber (417), one or more air fans (419), a filtering medium (421), a cleaned air evacuation chamber (423), and a frontal plate for the drive expansion bay slot (411A).

In a preferred embodiment of the invention, the one or more air fans (419) force nearby air inside the computer casing (401) to be sucked into the filtering chamber (417). The forced inflow of air into the filtering chamber (417) meets a first surface of the filtering medium (421) which faces the filtering chamber (417). Most dust particles or other foreign substances can be filtered by the filtering medium (421) at the first surface, and the cleaned air can pass through the filtering medium (421) to a second surface of the filtering medium (421) facing the cleaned air evacuation chamber (423). Then, the filtered air evacuates from the cleaned air evacuation chamber (423) through openings or micro holes on top, bottom, and sidewall surfaces of the cleaned air evacuation chamber (423). Because the one or more air fans (419) force and push an airflow into the filtering chamber (417) and the cleaned air evacuation chamber (423), the cleaned air in the cleaned air evacuation chamber (423) is at least indirectly pressured by the airflow forced and pushed by the one or more air fans (419) to escape through one or more openings in the cleaned air evacuation chamber (423).

In a preferred embodiment of the invention, the frontal plate for the drive expansion bay slot (411A) largely prevents the filtered air from escaping through a frontal surface of the dust-filtering apparatus (417, 419, 421, 423). This general blockage of cleaned air evacuation from the frontal surface, though optional for the scope of this invention, may prevent a computer user from experiencing a constant and annoying breeze during the operation of the dust-filtering apparatus (417, 419, 421, 423), because most of the cleaned air from the dust-filtering apparatus (417, 419, 421, 423) simply evacuates within the computer casing (401).

The dust-filtering apparatus (417, 419, 421, 423) as embodied by the present invention provides several advantages over conventional dust screens or other designs. First, by enabling a periodic or constant filtering of air inside a computer casing (e.g. 401), the present invention proactively and effectively eliminates a large portion of undesirable dusts which may accumulate inside the computer casing, regardless of a particular configuration of a main cooling fan (e.g. 403) for the computer casing (e.g. 401). Second, by making the dust-filtering apparatus (417, 419, 421, 423) insertable into a standardized drive expansion bay slot (e.g. 411A) of a desktop computer, the dimensions of the dust-filtering apparatus (417, 419, 421, 423) can be standardized for any desktop computers, regardless of their differences in other exterior or interior features. For example, a standardized drive expansion bay slot may require a 5.25-inch width and a 2-inch height per slot, which enables a manufacturer of the dust-filtering apparatus (417, 419, 421, 423) to design a single slot version and a multi-slot version of the apparatus, which may fit in most desktop computer designs. Furthermore, the dust-filtering apparatus (417, 419, 421, 423) as embodied by the present invention enables easy access and replacement of a filtering medium (421) by providing a front door on the frontal surface of the drive expansion bay slot (e.g. 411A).

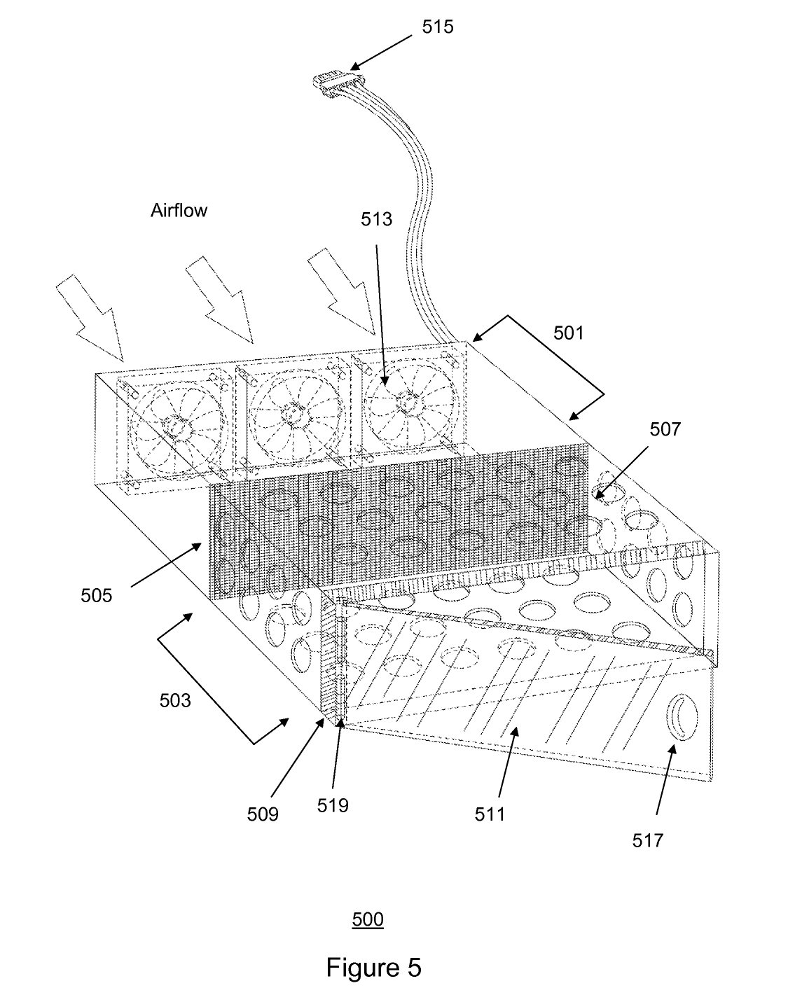

FIG. 5 shows a perspective diagram of a dust-filtering apparatus (500) with a door (511) with a hinge (519) on one edge near a cleaned air evacuation chamber and a knob (517) on the front faceplate of the door, in accordance with an embodiment of the invention. In a preferred embodiment of the invention, the dust-filtering apparatus (500) comprises an air fan (513) designed to cause an inflow of air from outside the dust-filtering apparatus (500) (i.e. other parts of a computer casing) into a filtering chamber (501) of the dust-filtering apparatus (500). The air fan (513) is operatively connected to an electrical power supply unit through a power connector (515). In the preferred embodiment of the invention, the electrical power supply unit may be sharing a same power source with other devices designed to fit into expansion slots.

The dust-filtering apparatus (500) also has a filtering medium (505) located between the filtering chamber (501) and a cleaned air evacuation chamber (503). In the preferred embodiment of the invention, the filtering medium (505) is designed to filter dust particles within the filtering chamber (501) and pass cleaned air to the cleaned air evacuation chamber (503). Furthermore, the dust-filtering apparatus (500) also has one or more openings (507) which allow the cleaned air to evacuate outside (i.e. to other parts of the computer casing) from the dust-filtering apparatus (500). In the preferred embodiment of the invention, the dust-filtering apparatus (500) has a door (511) or a front faceplate with an air-tight caulking material (509) to prevent much of cleaned air from escaping through a front surface of the dust-filtering apparatus (500). As shown in FIG. 5, the door (511) can be attached to the rest of the dust-filtering apparatus (500) by one or more hinges (519), and a knob (517) on the door (511) enables an easy opening of the door (511) for any maintenance activities related to the filtering medium (505). The door (511) or the front faceplate can also prevent the cleaned air from blowing directly out of one or more expansion bay front plates, which may be annoyance or inconvenience to a computer user.

Continuing with FIG. 5, a multiple number of air fans (513) can be used to force air into the filtering chamber (501) depending on desired air cleaning processing rates and capacities. In a preferred embodiment of the invention, the filtering medium (505) can be a HEPA (high efficiency particulate air) filter layer, a finely meshed screen, a paper filter, a fiber filter, a cartridge-type/box-shaped filter (e.g. 700 of FIG. 7), or any other material which effectively collect dusts on a first surface of the filtering medium (505) facing the filtering chamber (501) and pass cleaned air to the cleaned air evacuation chamber (503). The filtering medium (505) can also have an air-tight caulking material around outer edges of the filtering medium (505) to prevent accidental passage of the dust particles through the outer edges of the filtering medium (505) in the filtering chamber (501). Furthermore, the door (511) or the front faceplate of the dust-filtering apparatus (500) can be opened by a user for easy access, replacement, or cleaning of the filtering medium (505). In one embodiment of the invention as shown in FIG. 5, the door (511) may have a hinge (e.g. 519) and a knob (e.g. 517) for easy opening of the frontal surface of the dust-filtering apparatus (500). In the preferred embodiment of the invention, relatively few dusts may be present in the cleaned air evacuation chamber (503) because most dusts are collected by a first surface of filtering medium (505) facing the filtering chamber (501). Therefore, potential clogging of one or more openings (507) by dusts may be minimal or negligible on a second surface of the filtering medium (505) facing the cleaned air evacuation chamber (503) as long as the filtering medium (505) is regularly replaced or cleaned by the user.

Furthermore, in the preferred embodiment of the invention, the dust-filtering apparatus (500) is designed to be inserted into one or more slots for drive expansion bays, and the air fan (513) is operatively connected to an electrical power supply unit which also provides power to another device in another drive expansion bay. In addition, in one embodiment of the invention, the filtering chamber (501) is made of air-tight solid materials for top, bottom, and sidewalls to prevent escape of the inflow of air and to maximize air filtering effectiveness of the filtering medium (505) placed in a frontal portion of the filtering chamber (501).

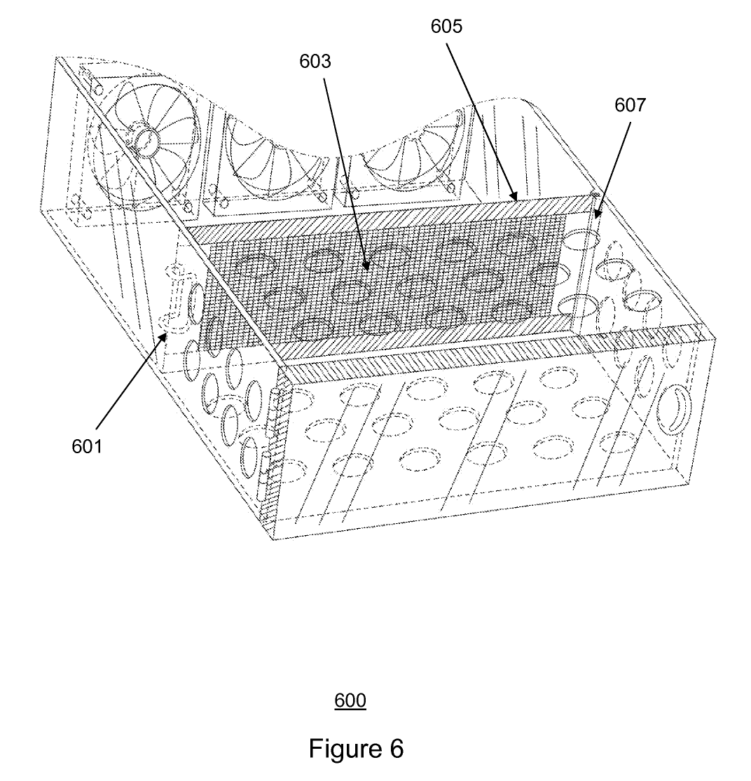

FIG. 6 shows a cutaway perspective diagram of a dust-filtering apparatus (600) with a filter holding clip (601) and a slide rail (607) for a filtering medium, in accordance with an embodiment of the invention. In one embodiment of the invention, a filtering medium (603) is held at a stationary position by using the slide rail (607) which anchors one side of the filtering medium (603) and the filter holding clip (601) on the opposite side of the filtering medium (603). The filter holding clip (601) may be moved or manipulated by a user to anchor the opposite side of the filtering medium. If the user wants to take the filtering medium (603) out of the dust-filtering apparatus (600), then the filter holding clip (601) may be moved or manipulated by the user again to dislocate the filtering medium (603) from the stationary position. The filtering medium (603) may also have air-tight or nearly air-tight caulking materials (605) which surrounds or encapsulates at least some edges of the filtering medium. Examples of the air-tight caulking materials (605) include, but are not limited to, rubber, silicone, and flexible plastics. The use of the air-tight or nearly air-tight caulking materials (605) can ensure that only filtered air can pass through the filtering medium (603) without letting much of the dust particles to pass through boundary edges of the filtering medium (603).

FIG. 7 shows a cartridge-type filtering medium (700) configured to slide into a filtering chamber (e.g. 501) of a dust-filtering apparatus, in accordance with an embodiment of the invention. If the cartridge-type filtering medium (700) is used instead of a layer-type filtering medium (e.g. 603), then a box-like structure with a large opening in a rear portion of the box-like structure can slide into the filtering chamber as a “cartridge,” if the door attached to a cleaned air evacuation chamber is opened. The large opening in the rear portion of the box-like structure is configured to receive an incoming airflow induced by air fans (e.g. 513). The cartridge-type filtering medium (700) generally has enclosed and air-tight top (703) and bottom surfaces and enclosed and air-tight sidewalls (701, 705). In a preferred embodiment of the invention, a frontal portion (707) of the cartridge-type filtering medium (700) is a HEPA filter, a paper filter, a fiber filter, or another type of filter.

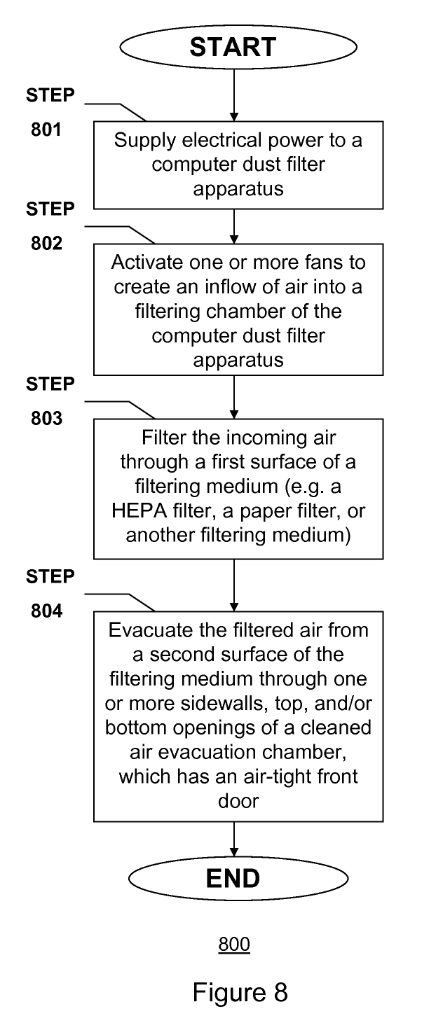

FIG. 8 shows a method (800) of operating a dust-filtering apparatus in accordance with an embodiment of the invention. In STEP 801, when a computer dust-filter apparatus is turned on, electrical power is supplied to the computer dust-filter apparatus. Then, the dust-filter apparatus activates one or more fans to create an inflow of air into a filtering chamber of the computer dust-filter apparatus, as shown in STEP 802. Subsequently, in STEP 803, the incoming air confronts a first surface of a filtering medium (e.g. a HEPA filter, a paper filter, or another filtering medium) and dust particles are filtered by the first surface. Then, the filtered (i.e. cleaned) air passes through a second surface of the filtering medium to a cleaned air evacuation chamber, which has one or more openings on top, bottom, and/or side surfaces, as shown in STEP 804.

The dust-filtering apparatus as embodied by the present invention provides several advantages over conventional dust screens or other designs. First, by enabling a periodic or constant filtering of air inside a computer casing, the present invention proactively and effectively eliminates a large portion of undesirable dusts which may accumulate inside the computer casing, regardless of a particular configuration of a main cooling fan for the computer casing. Second, by making the dust-filtering apparatus insertable into a standardized drive expansion bay slot of a desktop computer, the dimensions of the dust-filtering apparatus can be standardized for any desktop computers, regardless of their differences in other exterior or interior features. For example, a standardized drive expansion bay slot may require a 5.25-inch width and a 2-inch height per slot, which enables a manufacturer of the dust-filtering apparatus to design a single slot version and a multi-slot version of the apparatus, which may fit in most desktop computer designs. Furthermore, the dust-filtering apparatus as embodied by the present invention enables easy access and replacement of a filtering medium by providing a front door on the frontal surface of the drive expansion bay slot.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for filtering dust particles inside a computer casing, the apparatus comprising:
an air fan designed to cause an inflow of air from other parts of the computer casing into a filtering chamber of the apparatus, wherein the air fan is operatively connected to an electrical power supply unit;
a filtering medium located between the filtering chamber and a cleaned air evacuation chamber of the apparatus, wherein the filtering medium is designed to filter the dust particles within the filtering chamber and pass cleaned air to the cleaned air evacuation chamber; and
an opening in the cleaned air evacuation chamber, wherein the opening allows the cleaned air to evacuate to the other parts of the computer casing.

2. The apparatus of claim 1, further comprising a door on the cleaned air evacuation chamber for easy access to replacement and/or maintenance of the filtering medium, wherein the door has a hinge on one edge near the cleaned air evacuation chamber and a knob on a front faceplate of the door.

3. The apparatus of claim 2, further comprising an air-tight caulking material around the door to prevent any evacuation of the cleaned air through the door or the front faceplate of the door.

4. The apparatus of claim 1, wherein the filtering chamber is made of air-tight solid materials for top, bottom, and sidewalls to prevent escape of the inflow of air and to maximize air filtering effectiveness of the filtering medium placed in a frontal portion of the filtering chamber.

5. The apparatus of claim 1, wherein the filtering medium has a first surface facing the filtering chamber and a second surface facing the cleaned air evacuation chamber, and wherein the first surface of the filtering medium prevents at least some dust particles from passing to the second surface of the filtering medium.

6. The apparatus of claim 1, wherein the filtering medium is a HEPA filter, a paper filter, a fiber filter, or another type of filter designed to collect at least some dust particles on one surface of the filtering medium.

7. The apparatus of claim 1, further comprising an air-tight caulking material around outer edges of the filtering medium to prevent accidental passage of the dust particles through the outer edges of the filtering medium in the filtering chamber.

8. The apparatus of claim 1, wherein the apparatus for filtering the dust particles inside the computer casing is drive expansion bay-insertable and wherein the air fan is operatively connected to the electrical power supply unit which also provides power to another device in another drive expansion bay.

9. The apparatus of claim 8, wherein the apparatus for filtering the dust particles inside the computer casing can take two or more slots in drive expansion bays to incorporate more fans in the apparatus for a higher filtering capacity.

10. The apparatus of claim 1, further comprising a filter holding clip and/or a slide rail to hold the filtering medium to a stationary position.

11. The apparatus of claim 2, wherein the filtering medium is a cartridge type in which a box-like structure with a large opening in a rear portion of the box-like structure can slide into the filtering chamber of the apparatus from the door on the cleaned air evacuation chamber.

12. An expansion bay-insertable computer dust-filter apparatus comprising:
one or more air fans designed to cause an inflow of air from other parts of the computer casing into a filtering chamber of the expansion bay-insertable computer dust-filter apparatus, wherein the one or more air fans are operatively connected to an electrical power supply unit;
a filtering medium located between the filtering chamber and a cleaned air evacuation chamber of the expansion bay-insertable computer dust-filter apparatus, wherein the filtering medium is designed to filter the dust particles within the filtering chamber and pass cleaned air to the cleaned air evacuation chamber; and
a plurality of holes in the cleaned air evacuation chamber, wherein the plurality of holes allow the cleaned air to evacuate to the other parts of the computer casing.

13. The expansion bay-insertable computer dust-filter apparatus of claim 12, further comprising a door on the cleaned air evacuation chamber for easy access to replacement and/or maintenance of the filtering medium, wherein the door has a hinge on one edge near the cleaned air evacuation chamber and a knob on a front faceplate of the door.

14. The expansion bay-insertable computer dust-filter apparatus of claim 13, further comprising an air-tight caulking material around the door to prevent any evacuation of the cleaned air through the door or the front faceplate of the door.

15. The expansion bay-insertable computer dust-filter apparatus of claim 12, wherein the filtering chamber is made of air-tight solid materials for top, bottom, and sidewalls to prevent escape of the inflow of air and to maximize air filtering effectiveness of the filtering medium placed in a frontal portion of the filtering chamber.

16. The expansion bay-insertable computer dust-filter apparatus of claim 12, wherein the filtering medium has a first surface facing the filtering chamber and a second surface facing the cleaned air evacuation chamber, and wherein the first surface of the filtering medium prevents at least some dust particles from passing to the second surface of the filtering medium.

17. The expansion bay-insertable computer dust-filter apparatus of claim 12, wherein the filtering medium is a HEPA filter, a paper filter, a fiber filter, or another type of filter designed to collect at least some dust particles on one surface of the filtering medium.

18. The expansion bay-insertable computer dust-filter apparatus of claim 12, further comprising an air-tight caulking material around outer edges of the filtering medium to prevent accidental passage of the dust particles through the outer edges of the filtering medium in the filtering chamber.

19. The expansion bay-insertable computer dust-filter apparatus of claim 12, wherein the expansion bay-insertable computer dust-filter apparatus is drive expansion bay-insertable and wherein the one or more air fans are operatively connected to the electrical power supply unit which also provides power to another device in another drive expansion bay.

20. The expansion bay-insertable computer dust-filter apparatus of claim 19, wherein the expansion bay-insertable computer dust-filter apparatus can take two or more slots in drive expansion bays to incorporate more fans in the expansion bay-insertable computer dust-filter apparatus for a higher filtering capacity.
